(19) United States
(12) Patent Application Publication
(10) Pub. No.: US 2026/0063814 A1
(43) Pub. Date: Mar. 5, 2026

(54) SYSTEM

(71) Applicant: SoftBank Group Corp., Tokyo (JP)

(72) Inventor: Hideo HOSHINO, Tokyo (JP)

(21) Appl. No.: 19/304,735

(22) Filed: Aug. 20, 2025

(30) Foreign Application Priority Data
Aug. 30, 2024 (JP) 2024-149634

(51) Int. Cl. G01V 1/01; A01K 29/00; G06N 3/0475; G06N 20/00

(52) U.S. Cl. CPC G01V 1/01; A01K 29/005; G06N 3/0475; G06N 20/00

(57) ABSTRACT

The system according to the embodiment comprises a collection unit, an analysis unit, a generation unit, and a provision unit. The collection unit collects data from sensors attached to animals. The analysis unit analyzes the data collected by the collection unit. The generation unit generates prediction information based on the analysis results obtained by the analysis unit. The provision unit provides the prediction information generated by the generation unit.

### CROSS-REFERENCE TO RELATED APPLICATION

The present application claims priority to and incorporates by reference the entire contents of Japanese Patent Application No. 2024-149634 filed in Japan on Aug. 30, 2024.

### BACKGROUND OF THE INVENTION

### Field of the Invention

The technology of this disclosure relates to the system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, the use of animal behavioral data for earthquake prediction has not been sufficiently implemented, and there is room for improvement.

### SUMMARY OF THE INVENTION

The system according to the embodiment comprises a collection unit, an analysis unit, a generation unit, and a provision unit. The collection unit collects data from sensors attached to animals. The analysis unit analyzes the data collected by the collection unit. The generation unit generates prediction information based on the analysis results obtained by the analysis unit. The provision unit provides the prediction information generated by the generation unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

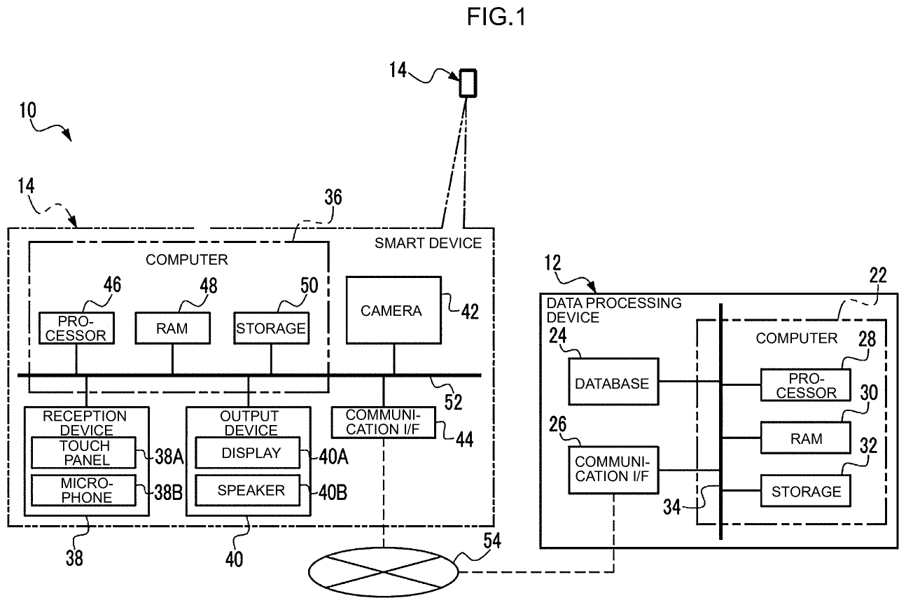

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

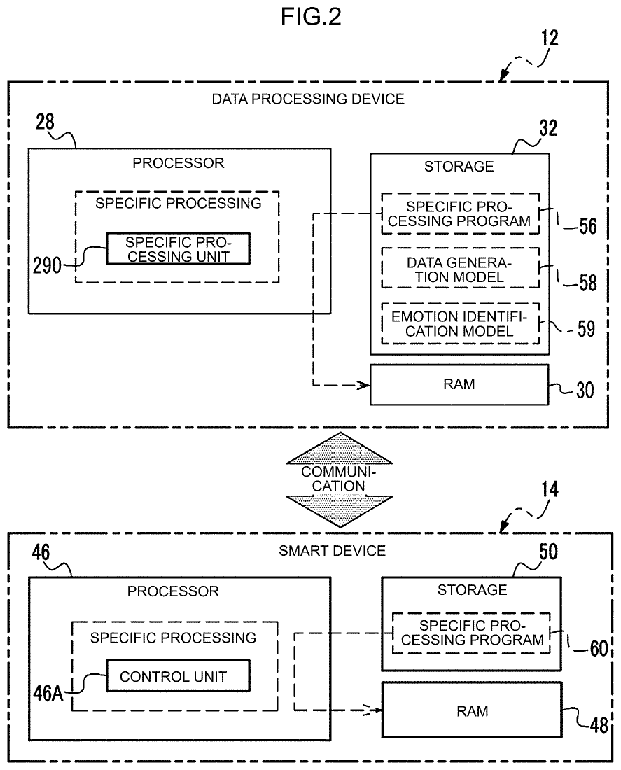

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The earthquake prediction system according to the embodiment of the present invention is a system that predicts earthquakes by utilizing the “biological body sensors” of living organisms. This earthquake prediction system digitizes sensor information from animals and collaborates with generative AI to accurately verbalize the information animals use to predict earthquakes and perform earthquake prediction. For example, the earthquake prediction system monitors the physical responses of animals in real time using sensors attached to the animals. For example, the sensors detect behaviors and physiological changes when animals such as dogs or cats sense precursors to earthquakes. This sensor information includes the animal's heart rate, body temperature, movement patterns, and so on. Next, the collected sensor information is digitized and input to the generative AI. The generative AI analyzes these data and extracts characteristic patterns when animals predict earthquakes. For example, it identifies that a specific increase in heart rate or abnormal movement patterns are precursors to earthquakes. The generative AI verbalizes earthquake prediction information based on the extracted patterns. For example, it generates specific prediction information such as “Since the dog's heart rate has rapidly increased and abnormal movements are observed, it is determined to be a precursor to an earthquake.” This prediction information is provided to the regional disaster prevention system, enabling advance warning of earthquake occurrence. As a result, local residents can evacuate early and minimize damage caused by earthquakes. Furthermore, this system can generate profits through the sale of sensors and regional contracts. For example, by selling sensors and providing services linked with generative AI to animal lovers or disaster-conscious regions, revenue can be obtained. In this way, a system that predicts earthquakes by utilizing the “biological body sensors” of living organisms can accurately perform earthquake prediction and reduce earthquake damage by digitizing animal sensor information and collaborating with generative AI. Thus, the earthquake prediction system can accurately perform earthquake prediction by digitizing animal sensor information and collaborating with generative AI.

The earthquake prediction system according to the embodiment comprises a collection unit, an analysis unit, a generation unit, and a provision unit. The collection unit collects data from sensors attached to animals. The sensors attached to animals may include, for example, heart rate sensors, body temperature sensors, and acceleration sensors, but are not limited to these examples. The collection unit, for example, uses a heart rate sensor to monitor the animal's heart rate in real time. The collection unit can also use a body temperature sensor to measure the animal's body temperature. Furthermore, the collection unit can use an acceleration sensor to detect the animal's movement patterns. For example, the collection unit detects fluctuations in the animal's heart rate using a heart rate sensor and collects data when abnormal fluctuations are detected. The collection unit can also detect changes in the animal's body temperature using a body temperature sensor and collect data when abnormal changes are detected. Furthermore, the collection unit can detect movement patterns using an acceleration sensor and collect data when abnormal movements are detected. The analysis unit analyzes the data collected by the collection unit. The analysis unit, for example, analyzes data using machine learning algorithms. Machine learning algorithms may include, for example, K-means, random forest, and so on, but are not limited to these examples. The analysis unit, for example, clusters data using K-means and determines that an abnormal cluster is a precursor to an earthquake. The analysis unit can also classify data using random forest and determine that an abnormal classification result is a precursor to an earthquake. Furthermore, the analysis unit can analyze data using a neural network and determine that an abnormal pattern is a precursor to an earthquake. The generation unit generates prediction information based on the analysis results obtained by the analysis unit. The generation unit, for example, generates prediction information using generative AI. Generative AI may include, for example, neural networks, generative models, and so on, but is not limited to these examples. The generation unit, for example, generates prediction information based on analysis results using a neural network. The generation unit can also generate prediction information based on analysis results using a generative model. Furthermore, the generation unit can generate prediction information based on analysis results using generative AI. The provision unit provides the prediction information generated by the generation unit. The provision unit, for example, provides the generated prediction information to a regional disaster prevention system. The regional disaster prevention system may include, for example, alarm systems, evacuation guidance systems, and so on, but is not limited to these examples. The provision unit, for example, notifies local residents of prediction information using an alarm system. The provision unit can also issue evacuation instructions based on prediction information using an evacuation guidance system. Furthermore, the provision unit can provide the generated prediction information to local residents via web applications or mobile applications. Thus, the earthquake prediction system according to the embodiment can accurately perform earthquake prediction by digitizing animal sensor information and collaborating with generative AI.

The collection unit may include a heart rate sensor, a body temperature sensor, and an acceleration sensor. The heart rate sensor is used to monitor the animal's heart rate in real time. For example, the heart rate sensor can be attached to the animal's collar to detect fluctuations in heart rate. The heart rate sensor can also be attached to the animal's chest to detect fluctuations in heart rate. Furthermore, the heart rate sensor can be attached to the animal's ear to detect fluctuations in heart rate. The body temperature sensor is used to measure the animal's body temperature. For example, the body temperature sensor can be attached to the animal's collar to detect changes in body temperature. The body temperature sensor can also be attached to the animal's chest to detect changes in body temperature. Furthermore, the body temperature sensor can be attached to the animal's ear to detect changes in body temperature. The acceleration sensor is used to detect the animal's movement patterns. For example, the acceleration sensor can be attached to the animal's collar to detect changes in movement. The acceleration sensor can also be attached to the animal's chest to detect changes in movement. Furthermore, the acceleration sensor can be attached to the animal's leg to detect changes in movement. By using various sensors in this way, the animal's physical responses can be monitored in detail. Some or all of the above-described processing in the collection unit may be performed using AI, or may be performed without using AI. For example, the collection unit can input the animal's heart rate data to generative AI to analyze fluctuations in heart rate. The collection unit can also input the animal's body temperature data to generative AI to analyze changes in body temperature. Furthermore, the collection unit can input the animal's movement pattern data to generative AI to analyze changes in movement.

The analysis unit can analyze data using machine learning algorithms. Machine learning algorithms are used to analyze the collected data. For example, K-means is used to cluster data. K-means divides data into multiple clusters and calculates the center of each cluster. Then, each data point is assigned to the nearest cluster. This allows identification of data patterns. Random forest is used to classify data. Random forest constructs multiple decision trees and aggregates the prediction results of each decision tree. This improves the accuracy of data classification. Furthermore, neural networks are used to analyze data. Neural networks are networks consisting of multiple layers, each of which processes input data and generates output. This allows identification of complex data patterns. For example, the analysis unit clusters the collected data using K-means and determines that an abnormal cluster is a precursor to an earthquake. The analysis unit can also classify the collected data using random forest and determine that an abnormal classification result is a precursor to an earthquake. Furthermore, the analysis unit can analyze the collected data using a neural network and determine that an abnormal pattern is a precursor to an earthquake. By using machine learning algorithms in this way, the accuracy of data analysis is improved. Some or all of the above-described processing in the analysis unit may be performed using AI, or may be performed without using AI. For example, the analysis unit can input the collected data to generative AI and have the generative AI perform the data analysis.

The generation unit can generate prediction information using generative AI. Generative AI is used to generate prediction information based on analysis results. For example, neural networks are used to generate prediction information based on analysis results. Neural networks are networks consisting of multiple layers, each of which processes input data and generates output. This allows identification of complex patterns in analysis results and generation of prediction information. Generative models are also used to generate prediction information based on analysis results. Generative models are models for generating new data based on input data and can generate prediction information based on analysis results. For example, the generation unit generates prediction information based on analysis results using a neural network. The generation unit can also generate prediction information based on analysis results using a generative model. Furthermore, the generation unit can generate prediction information based on analysis results using generative AI. By using generative AI in this way, the accuracy of prediction information is improved. Some or all of the above-described processing in the generation unit may be performed using AI, or may be performed without using AI. For example, the generation unit can input analysis results to generative AI and have the generative AI perform the generation of prediction information.

The provision unit can provide the generated prediction information to a regional disaster prevention system. The regional disaster prevention system may include, for example, alarm systems, evacuation guidance systems, and so on. The alarm system is used to notify local residents of the occurrence of an earthquake. For example, the alarm system notifies local residents of the occurrence of an earthquake via voice alarms or text messages. The alarm system can also notify the occurrence of an earthquake via local television or radio. Furthermore, the alarm system can notify the occurrence of an earthquake via local websites or mobile applications. The evacuation guidance system is used to guide local residents to safe locations in the event of an earthquake. For example, the evacuation guidance system guides local residents to evacuation routes via voice guidance or text messages. The evacuation guidance system can also guide evacuation routes via local television or radio. Furthermore, the evacuation guidance system can guide evacuation routes via local websites or mobile applications. By providing prediction information to the regional disaster prevention system in this way, advance warning of earthquake occurrence is possible. Some or all of the above-described processing in the provision unit may be performed using AI, or may be performed without using AI. For example, the provision unit can input the generated prediction information to generative AI and have the generative AI perform the method of providing it to the regional disaster prevention system.

The collection unit can analyze the animal's past behavioral history and select the optimal sensor placement. The collection unit analyzes the animal's past behavioral history and selects the optimal sensor placement. For example, if the animal has exhibited abnormal behavior at a specific location in the past, sensors are concentrated at that location. The placement of heart rate sensors and body temperature sensors can also be optimized based on the animal's past behavioral patterns. Furthermore, if the animal exhibits abnormal behavior at a specific time of day, the sensitivity of the sensors can be increased during that time period. For example, the collection unit analyzes the animal's behavior logs and places sensors in locations where abnormal behavior frequently occurs. The collection unit can also analyze the animal's location data and adjust the sensitivity of the sensors during time periods when abnormal behavior frequently occurs. Furthermore, the collection unit can analyze the animal's behavioral patterns and place sensors in locations and time periods where abnormal behavior frequently occurs. By selecting the optimal sensor placement based on the animal's past behavioral history in this way, the accuracy of data collection is improved. Some or all of the above-described processing in the collection unit may be performed using AI, or may be performed without using AI. For example, the collection unit can input the animal's behavioral history data to generative AI and have the generative AI select the optimal sensor placement.

The collection unit can perform filtering based on the animal's current health status when collecting data from the sensors. The collection unit performs filtering based on the animal's current health status when collecting data from the sensors. For example, if the animal is healthy, normal data collection is performed. If the animal is ill, abnormal data can be filtered to collect accurate data. Furthermore, if the animal is tired, the frequency of data collection can be adjusted to reduce the burden. For example, the collection unit analyzes the animal's health checkup data and performs normal data collection when the health status is good. The collection unit can also analyze the animal's vital sign data and filter abnormal data. Furthermore, the collection unit can monitor the animal's health status in real time and adjust the frequency of data collection according to the fatigue state. By filtering data according to the animal's health status in this way, accurate data can be collected. Some or all of the above-described processing in the collection unit may be performed using AI, or may be performed without using AI. For example, the collection unit can input the animal's health status data to generative AI and have the generative AI perform the data filtering.

The collection unit can prioritize the collection of highly relevant data by considering the animal's geographic location information when collecting data from the sensors. The collection unit prioritizes the collection of highly relevant data by considering the animal's geographic location information when collecting data from the sensors. For example, if the animal is in a specific region, data from that region is collected preferentially. If the animal is moving, data along the movement route can also be collected preferentially. Furthermore, if the animal exhibits abnormal behavior at a specific location, data from that location can also be collected preferentially. For example, the collection unit analyzes the animal's GPS data and collects data from that region preferentially when the animal is in a specific region. The collection unit can also analyze the animal's movement route data and collect data along the movement route preferentially when the animal is moving. Furthermore, the collection unit can analyze the animal's behavioral pattern data and collect data from that location preferentially when the animal exhibits abnormal behavior at a specific location. By considering the animal's geographic location information in this way, highly relevant data can be collected preferentially. Some or all of the above-described processing in the collection unit may be performed using AI, or may be performed without using AI. For example, the collection unit can input the animal's geographic location information data to generative AI and have the generative AI perform the prioritized collection of highly relevant data.

The collection unit can analyze the animal owner's social media activity when collecting data from the sensors and collect relevant data. The collection unit analyzes the animal owner's social media activity when collecting data from the sensors and collects relevant data. For example, if the owner reports abnormal behavior of the animal on social media, data related to that behavior is collected. If the owner is participating in a specific event, data related to that event can also be collected. Furthermore, if the owner shares the animal's health status on social media, data can also be collected based on that information. For example, the collection unit analyzes the owner's social media posts and collects data related to the animal's abnormal behavior. The collection unit can also analyze the owner's social media activity and collect data related to specific events. Furthermore, the collection unit can analyze the owner's social media posts and collect data related to the animal's health status. By analyzing the owner's social media activity in this way, relevant data can be collected. Some or all of the above-described processing in the collection unit may be performed using AI, or may be performed without using AI. For example, the collection unit can input the owner's social media data to generative AI and have the generative AI perform the collection of relevant data.

The analysis unit can refer to the animal's past data during analysis to improve the accuracy of the analysis. The analysis unit refers to the animal's past data during analysis to improve the accuracy of the analysis. For example, the animal's past heart rate data is referenced to analyze the current data. The animal's past body temperature data can also be referenced to analyze the current data. Furthermore, the animal's past movement pattern data can also be referenced to analyze the current data. For example, the analysis unit analyzes the animal's past heart rate data and compares it with the current heart rate data. The analysis unit can also analyze the animal's past body temperature data and compare it with the current body temperature data. Furthermore, the analysis unit can analyze the animal's past movement pattern data and compare it with the current movement pattern data. By referring to the animal's past data in this way, the accuracy of the analysis is improved. Some or all of the above-described processing in the analysis unit may be performed using AI, or may be performed without using AI. For example, the analysis unit can input the animal's past data to generative AI and have the generative AI perform the accuracy improvement of the analysis.

The analysis unit can apply different analysis methods for each animal species during analysis. The analysis unit applies different analysis methods for each animal species during analysis. For example, when analyzing dog data, an analysis method that takes into account dog-specific behavioral patterns is applied. When analyzing cat data, an analysis method that takes into account cat-specific behavioral patterns can also be applied. Furthermore, when analyzing bird data, an analysis method that takes into account bird-specific behavioral patterns can also be applied. For example, the analysis unit analyzes dog behavioral patterns and applies an analysis method that takes into account dog-specific behavioral patterns. The analysis unit can also analyze cat behavioral patterns and apply an analysis method that takes into account cat-specific behavioral patterns. Furthermore, the analysis unit can analyze bird behavioral patterns and apply an analysis method that takes into account bird-specific behavioral patterns. By applying different analysis methods for each animal species in this way, the accuracy of the analysis is improved. Some or all of the above-described processing in the analysis unit may be performed using AI, or may be performed without using AI. For example, the analysis unit can input data for each animal species to generative AI and have the generative AI perform the application of different analysis methods.

The analysis unit can perform analysis by considering the animal's geographic distribution during analysis. The analysis unit performs analysis by considering the animal's geographic distribution during analysis. For example, if the animal is in a specific region, data from that region is prioritized for analysis. If the animal is moving, data along the movement route can also be prioritized for analysis. Furthermore, if the animal exhibits abnormal behavior at a specific location, data from that location can also be prioritized for analysis. For example, the analysis unit analyzes the animal's GPS data and prioritizes the analysis of data from that region when the animal is in a specific region. The analysis unit can also analyze the animal's movement route data and prioritize the analysis of data along the movement route when the animal is moving. Furthermore, the analysis unit can analyze the animal's behavioral pattern data and prioritize the analysis of data from that location when the animal exhibits abnormal behavior at a specific location. By considering the animal's geographic distribution in this way, more relevant analysis is possible. Some or all of the above-described processing in the analysis unit may be performed using AI, or may be performed without using AI. For example, the analysis unit can input the animal's geographic distribution data to generative AI and have the generative AI perform the prioritized analysis of highly relevant data.

The analysis unit can refer to related literature on animals during analysis to improve the accuracy of the analysis. The analysis unit refers to related literature on animals during analysis to improve the accuracy of the analysis. For example, the latest research papers on animal behavior are referenced for analysis. Literature on physiological changes in animals can also be referenced for analysis. Furthermore, past research data on animal earthquake prediction can also be referenced for analysis. For example, the analysis unit refers to the latest research papers on animal behavior and reflects them in the analysis. The analysis unit can also refer to literature on physiological changes in animals and reflect them in the analysis. Furthermore, the analysis unit can refer to past research data on animal earthquake prediction and reflect them in the analysis. By referring to related literature on animals in this way, the accuracy of the analysis is improved. Some or all of the above-described processing in the analysis unit may be performed using AI, or may be performed without using AI. For example, the analysis unit can input related literature data on animals to generative AI and have the generative AI perform the accuracy improvement of the analysis.

The generation unit can refer to the animal's past behavioral patterns when generating prediction information to improve the accuracy of generation. The generation unit refers to the animal's past behavioral patterns when generating prediction information to improve the accuracy of generation. For example, the animal's past heart rate data is referenced to generate current prediction information. The animal's past body temperature data can also be referenced to generate current prediction information. Furthermore, the animal's past movement pattern data can also be referenced to generate current prediction information. For example, the generation unit analyzes the animal's past heart rate data and generates prediction information by comparing it with the current heart rate data. The generation unit can also analyze the animal's past body temperature data and generate prediction information by comparing it with the current body temperature data. Furthermore, the generation unit can analyze the animal's past movement pattern data and generate prediction information by comparing it with the current movement pattern data. By referring to the animal's past behavioral patterns in this way, the accuracy of prediction information is improved. Some or all of the above-described processing in the generation unit may be performed using AI, or may be performed without using AI. For example, the generation unit can input the animal's past behavioral pattern data to generative AI and have the generative AI perform the accuracy improvement of prediction information generation.

The generation unit can apply different generation algorithms for each animal species when generating prediction information. The generation unit applies different generation algorithms for each animal species when generating prediction information. For example, when generating prediction information based on dog data, a generation algorithm that takes into account dog-specific behavioral patterns is applied. When generating prediction information based on cat data, a generation algorithm that takes into account cat-specific behavioral patterns can also be applied. Furthermore, when generating prediction information based on bird data, a generation algorithm that takes into account bird-specific behavioral patterns can also be applied. For example, the generation unit analyzes dog behavioral patterns and applies a generation algorithm that takes into account dog-specific behavioral patterns. The generation unit can also analyze cat behavioral patterns and apply a generation algorithm that takes into account cat-specific behavioral patterns. Furthermore, the generation unit can analyze bird behavioral patterns and apply a generation algorithm that takes into account bird-specific behavioral patterns. By applying different generation algorithms for each animal species in this way, the accuracy of prediction information is improved. Some or all of the above-described processing in the generation unit may be performed using AI, or may be performed without using AI. For example, the generation unit can input data for each animal species to generative AI and have the generative AI perform the application of different generation algorithms.

The generation unit can perform generation by considering the animal's geographic distribution when generating prediction information. The generation unit performs generation by considering the animal's geographic distribution when generating prediction information. For example, if the animal is in a specific region, prediction information is generated based on data from that region. If the animal is moving, prediction information can also be generated based on data along the movement route. Furthermore, if the animal exhibits abnormal behavior at a specific location, prediction information can also be generated based on data from that location. For example, the generation unit analyzes the animal's GPS data and generates prediction information based on data from that region when the animal is in a specific region. The generation unit can also analyze the animal's movement route data and generate prediction information based on data along the movement route when the animal is moving. Furthermore, the generation unit can analyze the animal's behavioral pattern data and generate prediction information based on data from that location when the animal exhibits abnormal behavior at a specific location. By considering the animal's geographic distribution in this way, more relevant prediction information can be generated. Some or all of the above-described processing in the generation unit may be performed using AI, or may be performed without using AI. For example, the generation unit can input the animal's geographic distribution data to generative AI and have the generative AI perform the prioritized generation of highly relevant data.

The generation unit can refer to related literature on animals when generating prediction information to improve the accuracy of generation. The generation unit refers to related literature on animals when generating prediction information to improve the accuracy of generation. For example, the latest research papers on animal behavior are referenced to generate prediction information. Literature on physiological changes in animals can also be referenced to generate prediction information. Furthermore, past research data on animal earthquake prediction can also be referenced to generate prediction information. For example, the generation unit refers to the latest research papers on animal behavior and reflects them in the prediction information. The generation unit can also refer to literature on physiological changes in animals and reflect them in the prediction information. Furthermore, the generation unit can refer to past research data on animal earthquake prediction and reflect them in the prediction information. By referring to related literature on animals in this way, the accuracy of prediction information is improved. Some or all of the above-described processing in the generation unit may be performed using AI, or may be performed without using AI. For example, the generation unit can input related literature data on animals to generative AI and have the generative AI perform the accuracy improvement of prediction information generation.

The provision unit can refer to past earthquake data of the region when providing prediction information to improve the accuracy of provision. The provision unit refers to past earthquake data of the region when providing prediction information to improve the accuracy of provision. For example, current prediction information is provided based on past earthquake data of the region. The reliability of prediction information can also be improved by referring to past earthquake data of the region. Furthermore, the method of providing prediction information can be adjusted based on past earthquake data of the region. For example, the provision unit analyzes past earthquake records of the region and reflects them in the current prediction information. The provision unit can also analyze past seismic intensity data of the region and improve the reliability of prediction information. Furthermore, the provision unit can adjust the method of providing prediction information based on past earthquake data of the region. By referring to past earthquake data of the region in this way, the reliability of prediction information is improved. Some or all of the above-described processing in the provision unit may be performed using AI, or may be performed without using AI. For example, the provision unit can input past earthquake data of the region to generative AI and have the generative AI perform the accuracy improvement of prediction information provision.

The provision unit can apply different provision methods for each regional disaster prevention system when providing prediction information. The provision unit applies different provision methods for each regional disaster prevention system when providing prediction information. For example, if the regional disaster prevention system uses SMS notifications, prediction information is provided via SMS. If the regional disaster prevention system uses app notifications, prediction information can also be provided via app notifications. Furthermore, if the regional disaster prevention system uses email notifications, prediction information can also be provided via email. For example, the provision unit analyzes the type of regional disaster prevention system and provides prediction information via SMS if SMS notifications are used. The provision unit can also provide prediction information via app notifications if the regional disaster prevention system uses app notifications. Furthermore, the provision unit can provide prediction information via email if the regional disaster prevention system uses email notifications. By applying provision methods according to the regional disaster prevention system in this way, more effective information provision is possible. Some or all of the above-described processing in the provision unit may be performed using AI, or may be performed without using AI. For example, the provision unit can input regional disaster prevention system data to generative AI and have the generative AI perform the application of different provision methods.

The provision unit can provide prediction information by considering the geographic characteristics of the region when providing prediction information. The provision unit provides prediction information by considering the geographic characteristics of the region when providing prediction information. For example, if the region is a mountainous area, prediction information is provided considering the impact of earthquakes. If the region is an urban area, prediction information can also be provided considering the building density. Furthermore, if the region is a coastal area, prediction information can also be provided considering the risk of tsunamis. For example, the provision unit analyzes the region's topographic data and provides prediction information considering the impact of earthquakes if it is a mountainous area. The provision unit can also analyze the region's population distribution data and provide prediction information considering the building density if it is an urban area. Furthermore, the provision unit can analyze the region's coastal data and provide prediction information considering the risk of tsunamis if it is a coastal area. By considering the geographic characteristics of the region in this way, more relevant information provision is possible. Some or all of the above-described processing in the provision unit may be performed using AI, or may be performed without using AI. For example, the provision unit can input the region's geographic characteristic data to generative AI and have the generative AI perform the provision of highly relevant information.

The provision unit can refer to related literature of the region when providing prediction information to improve the accuracy of provision. The provision unit refers to related literature of the region when providing prediction information to improve the accuracy of provision. For example, prediction information is provided by referring to the latest research papers on earthquakes in the region. Prediction information can also be provided by referring to literature on disaster prevention in the region. Furthermore, prediction information can also be provided by referring to past earthquake data of the region. For example, the provision unit refers to the latest research papers on earthquakes in the region and reflects them in the prediction information. The provision unit can also refer to literature on disaster prevention in the region and reflect them in the prediction information. Furthermore, the provision unit can refer to past earthquake data of the region and reflect them in the prediction information. By referring to related literature of the region in this way, the accuracy of prediction information is improved. Some or all of the above-described processing in the provision unit may be performed using AI, or may be performed without using AI. For example, the provision unit can input related literature data of the region to generative AI and have the generative AI perform the accuracy improvement of prediction information provision.

The system according to the embodiment is not limited to the examples described above, and various modifications are possible, for example, as follows.

The collection unit can analyze the animal's past behavioral history and select the optimal sensor placement. For example, if the animal has exhibited abnormal behavior at a specific location in the past, sensors are concentrated at that location. The placement of heart rate sensors and body temperature sensors can also be optimized based on the animal's past behavioral patterns. Furthermore, if the animal exhibits abnormal behavior at a specific time of day, the sensitivity of the sensors can be increased during that time period. By selecting the optimal sensor placement based on the animal's past behavioral history in this way, the accuracy of data collection is improved.

The collection unit can perform filtering based on the animal's current health status when collecting data from the sensors. For example, if the animal is healthy, normal data collection is performed. If the animal is ill, abnormal data can be filtered to collect accurate data. Furthermore, if the animal is tired, the frequency of data collection can be adjusted to reduce the burden. By filtering data according to the animal's health status in this way, accurate data can be collected.

The collection unit can prioritize the collection of highly relevant data by considering the animal's geographic location information when collecting data from the sensors. For example, if the animal is in a specific region, data from that region is collected preferentially. If the animal is moving, data along the movement route can also be collected preferentially. Furthermore, if the animal exhibits abnormal behavior at a specific location, data from that location can also be collected preferentially. By considering the animal's geographic location information in this way, highly relevant data can be collected preferentially.

The analysis unit can refer to the animal's past data during analysis to improve the accuracy of the analysis. For example, the animal's past heart rate data is referenced to analyze the current data. The animal's past body temperature data can also be referenced to analyze the current data. Furthermore, the animal's past movement pattern data can also be referenced to analyze the current data. By referring to the animal's past data in this way, the accuracy of the analysis is improved.

The analysis unit can apply different analysis methods for each animal species during analysis. For example, when analyzing dog data, an analysis method that takes into account dog-specific behavioral patterns is applied. When analyzing cat data, an analysis method that takes into account cat-specific behavioral patterns can also be applied. Furthermore, when analyzing bird data, an analysis method that takes into account bird-specific behavioral patterns can also be applied. By applying different analysis methods for each animal species in this way, the accuracy of the analysis is improved.

The analysis unit can perform analysis by considering the animal's geographic distribution during analysis. For example, if the animal is in a specific region, data from that region is prioritized for analysis. If the animal is moving, data along the movement route can also be prioritized for analysis. Furthermore, if the animal exhibits abnormal behavior at a specific location, data from that location can also be prioritized for analysis. By considering the animal's geographic distribution in this way, more relevant analysis is possible.

Below is a brief explanation of the process flow of Example 1 of the Embodiment.
Step 1: The collection unit collects data from sensors attached to animals. The sensors attached to animals include heart rate sensors, body temperature sensors, and acceleration sensors. The collection unit uses a heart rate sensor to monitor the animal's heart rate in real time, a body temperature sensor to measure the animal's body temperature, and an acceleration sensor to detect the animal's movement patterns. Data is collected when abnormal fluctuations or changes are detected.
Step 2: The analysis unit analyzes the data collected by the collection unit. The analysis unit analyzes the data using machine learning algorithms (for example, K-means, random forest, neural networks), and determines that an abnormal cluster, classification result, or pattern is a precursor to an earthquake.
Step 3: The generation unit generates prediction information based on the analysis results obtained by the analysis unit. The generation unit generates prediction information based on the analysis results using generative AI (for example, neural networks, generative models).
Step 4: The provision unit provides the prediction information generated by the generation unit. The provision unit provides the generated prediction information to regional disaster prevention systems (for example, alarm systems, evacuation guidance systems) and notifies local residents. The information can also be provided to local residents via web applications or mobile applications.

### Example 2 of the Embodiment

The earthquake prediction system according to the embodiment of the present invention is a system that predicts earthquakes by utilizing the “biological body sensors” of living organisms. This earthquake prediction system digitizes sensor information from animals and collaborates with generative AI to accurately verbalize the information animals use to predict earthquakes and perform earthquake prediction. For example, the earthquake prediction system monitors the physical responses of animals in real time using sensors attached to the animals. For example, the sensors detect behaviors and physiological changes when animals such as dogs or cats sense precursors to earthquakes. This sensor information includes the animal's heart rate, body temperature, movement patterns, and so on. Next, the collected sensor information is digitized and input to the generative AI. The generative AI analyzes these data and extracts characteristic patterns when animals predict earthquakes. For example, it identifies that a specific increase in heart rate or abnormal movement patterns are precursors to earthquakes. The generative AI verbalizes earthquake prediction information based on the extracted patterns. For example, it generates specific prediction information such as “Since the dog's heart rate has rapidly increased and abnormal movements are observed, it is determined to be a precursor to an earthquake.” This prediction information is provided to the regional disaster prevention system, enabling advance warning of earthquake occurrence. As a result, local residents can evacuate early and minimize damage caused by earthquakes. Furthermore, this system can generate profits through the sale of sensors and regional contracts. For example, by selling sensors and providing services linked with generative AI to animal lovers or disaster-conscious regions, revenue can be obtained. In this way, a system that predicts earthquakes by utilizing the “biological body sensors” of living organisms can accurately perform earthquake prediction and reduce earthquake damage by digitizing animal sensor information and collaborating with generative AI. Thus, the earthquake prediction system can accurately perform earthquake prediction by digitizing animal sensor information and collaborating with generative AI.

The earthquake prediction system according to the embodiment comprises a collection unit, an analysis unit, a generation unit, and a provision unit. The collection unit collects data from sensors attached to animals. The sensors attached to animals may include, for example, heart rate sensors, body temperature sensors, and acceleration sensors, but are not limited to these examples. The collection unit, for example, uses a heart rate sensor to monitor the animal's heart rate in real time. The collection unit can also use a body temperature sensor to measure the animal's body temperature. Furthermore, the collection unit can use an acceleration sensor to detect the animal's movement patterns. For example, the collection unit detects fluctuations in the animal's heart rate using a heart rate sensor and collects data when abnormal fluctuations are detected. The collection unit can also detect changes in the animal's body temperature using a body temperature sensor and collect data when abnormal changes are detected. Furthermore, the collection unit can detect movement patterns using an acceleration sensor and collect data when abnormal movements are detected. The analysis unit analyzes the data collected by the collection unit. The analysis unit, for example, analyzes data using machine learning algorithms. Machine learning algorithms may include, for example, K-means, random forest, and so on, but are not limited to these examples. The analysis unit, for example, clusters data using K-means and determines that an abnormal cluster is a precursor to an earthquake. The analysis unit can also classify data using random forest and determine that an abnormal classification result is a precursor to an earthquake. Furthermore, the analysis unit can analyze data using a neural network and determine that an abnormal pattern is a precursor to an earthquake. The generation unit generates prediction information based on the analysis results obtained by the analysis unit. The generation unit, for example, generates prediction information using generative AI. Generative AI may include, for example, neural networks, generative models, and so on, but is not limited to these examples. The generation unit, for example, generates prediction information based on analysis results using a neural network. The generation unit can also generate prediction information based on analysis results using a generative model. Furthermore, the generation unit can generate prediction information based on analysis results using generative AI. The provision unit provides the prediction information generated by the generation unit. The provision unit, for example, provides the generated prediction information to a regional disaster prevention system. The regional disaster prevention system may include, for example, alarm systems, evacuation guidance systems, and so on, but is not limited to these examples. The provision unit, for example, notifies local residents of prediction information using an alarm system. The provision unit can also issue evacuation instructions based on prediction information using an evacuation guidance system. Furthermore, the provision unit can provide the generated prediction information to local residents via web applications or mobile applications. Thus, the earthquake prediction system according to the embodiment can accurately perform earthquake prediction by digitizing animal sensor information and collaborating with generative AI.

The collection unit may include a heart rate sensor, a body temperature sensor, and an acceleration sensor. The heart rate sensor is used to monitor the animal's heart rate in real time. For example, the heart rate sensor can be attached to the animal's collar to detect fluctuations in heart rate. The heart rate sensor can also be attached to the animal's chest to detect fluctuations in heart rate. Furthermore, the heart rate sensor can be attached to the animal's ear to detect fluctuations in heart rate. The body temperature sensor is used to measure the animal's body temperature. For example, the body temperature sensor can be attached to the animal's collar to detect changes in body temperature. The body temperature sensor can also be attached to the animal's chest to detect changes in body temperature. Furthermore, the body temperature sensor can be attached to the animal's ear to detect changes in body temperature. The acceleration sensor is used to detect the animal's movement patterns. For example, the acceleration sensor can be attached to the animal's collar to detect changes in movement. The acceleration sensor can also be attached to the animal's chest to detect changes in movement. Furthermore, the acceleration sensor can be attached to the animal's leg to detect changes in movement. By using various sensors in this way, the animal's physical responses can be monitored in detail. Some or all of the above-described processing in the collection unit may be performed using AI, or may be performed without using AI. For example, the collection unit can input the animal's heart rate data to generative AI to analyze fluctuations in heart rate. The collection unit can also input the animal's body temperature data to generative AI to analyze changes in body temperature. Furthermore, the collection unit can input the animal's movement pattern data to generative AI to analyze changes in movement.

The analysis unit can analyze data using machine learning algorithms. Machine learning algorithms are used to analyze the collected data. For example, K-means is used to cluster data. K-means divides data into multiple clusters and calculates the center of each cluster. Then, each data point is assigned to the nearest cluster. This allows identification of data patterns. Random forest is used to classify data. Random forest constructs multiple decision trees and aggregates the prediction results of each decision tree. This improves the accuracy of data classification. Furthermore, neural networks are used to analyze data. Neural networks are networks consisting of multiple layers, each of which processes input data and generates output. This allows identification of complex data patterns. For example, the analysis unit clusters the collected data using K-means and determines that an abnormal cluster is a precursor to an earthquake. The analysis unit can also classify the collected data using random forest and determine that an abnormal classification result is a precursor to an earthquake. Furthermore, the analysis unit can analyze the collected data using a neural network and determine that an abnormal pattern is a precursor to an earthquake. By using machine learning algorithms in this way, the accuracy of data analysis is improved. Some or all of the above-described processing in the analysis unit may be performed using AI, or may be performed without using AI. For example, the analysis unit can input the collected data to generative AI and have the generative AI perform the data analysis.

The generation unit can generate prediction information using generative AI. Generative AI is used to generate prediction information based on analysis results. For example, neural networks are used to generate prediction information based on analysis results. Neural networks are networks consisting of multiple layers, each of which processes input data and generates output. This allows identification of complex patterns in analysis results and generation of prediction information. Generative models are also used to generate prediction information based on analysis results. Generative models are models for generating new data based on input data and can generate prediction information based on analysis results. For example, the generation unit generates prediction information based on analysis results using a neural network. The generation unit can also generate prediction information based on analysis results using a generative model. Furthermore, the generation unit can generate prediction information based on analysis results using generative AI. By using generative AI in this way, the accuracy of prediction information is improved. Some or all of the above-described processing in the generation unit may be performed using AI, or may be performed without using AI. For example, the generation unit can input analysis results to generative AI and have the generative AI perform the generation of prediction information.

The provision unit can provide the generated prediction information to a regional disaster prevention system. The regional disaster prevention system may include, for example, alarm systems, evacuation guidance systems, and so on. The alarm system is used to notify local residents of the occurrence of an earthquake. For example, the alarm system notifies local residents of the occurrence of an earthquake via voice alarms or text messages. The alarm system can also notify the occurrence of an earthquake via local television or radio. Furthermore, the alarm system can notify the occurrence of an earthquake via local websites or mobile applications. The evacuation guidance system is used to guide local residents to safe locations in the event of an earthquake. For example, the evacuation guidance system guides local residents to evacuation routes via voice guidance or text messages. The evacuation guidance system can also guide evacuation routes via local television or radio. Furthermore, the evacuation guidance system can guide evacuation routes via local websites or mobile applications. By providing prediction information to the regional disaster prevention system in this way, advance warning of earthquake occurrence is possible. Some or all of the above-described processing in the provision unit may be performed using AI, or may be performed without using AI. For example, the provision unit can input the generated prediction information to generative AI and have the generative AI perform the method of providing it to the regional disaster prevention system.

The collection unit can estimate the emotion of an animal and adjust the sensitivity of the sensor based on the estimated emotion of the animal. The collection unit estimates the emotion of an animal and adjusts the sensitivity of the sensor based on the estimated emotion of the animal. For example, if the animal is excited, the sensitivity of the heart rate sensor is increased to collect detailed data. If the animal is relaxed, the sensitivity of the body temperature sensor can be adjusted to detect subtle changes. Furthermore, if the animal is anxious, the sensitivity of the acceleration sensor can be increased to record movement patterns in detail. For example, the collection unit analyzes the animal's heart rate data and increases the sensitivity of the sensor when there are large fluctuations in heart rate. The collection unit can also analyze the animal's body temperature data and adjust the sensitivity of the sensor when there are large fluctuations in body temperature. Furthermore, the collection unit can analyze the animal's movement pattern data and increase the sensitivity of the sensor when there are large fluctuations in movement. By adjusting the sensitivity of the sensors according to the animal's emotions in this way, more accurate data can be collected. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the collection unit may be performed using AI, or may be performed without using AI. For example, the collection unit can input the animal's emotion data to generative AI and have the generative AI perform the adjustment of sensor sensitivity based on emotion.

The collection unit can analyze the animal's past behavioral history and select the optimal sensor placement. The collection unit analyzes the animal's past behavioral history and selects the optimal sensor placement. For example, if the animal has exhibited abnormal behavior at a specific location in the past, sensors are concentrated at that location. The placement of heart rate sensors and body temperature sensors can also be optimized based on the animal's past behavioral patterns. Furthermore, if the animal exhibits abnormal behavior at a specific time of day, the sensitivity of the sensors can be increased during that time period. For example, the collection unit analyzes the animal's behavior logs and places sensors in locations where abnormal behavior frequently occurs. The collection unit can also analyze the animal's location data and adjust the sensitivity of the sensors during time periods when abnormal behavior frequently occurs. Furthermore, the collection unit can analyze the animal's behavioral patterns and place sensors in locations and time periods where abnormal behavior frequently occurs. By selecting the optimal sensor placement based on the animal's past behavioral history in this way, the accuracy of data collection is improved. Some or all of the above-described processing in the collection unit may be performed using AI, or may be performed without using AI. For example, the collection unit can input the animal's behavioral history data to generative AI and have the generative AI select the optimal sensor placement.

The collection unit can perform filtering based on the animal's current health status when collecting data from the sensors. The collection unit performs filtering based on the animal's current health status when collecting data from the sensors. For example, if the animal is healthy, normal data collection is performed. If the animal is ill, abnormal data can be filtered to collect accurate data. Furthermore, if the animal is tired, the frequency of data collection can be adjusted to reduce the burden. For example, the collection unit analyzes the animal's health checkup data and performs normal data collection when the health status is good. The collection unit can also analyze the animal's vital sign data and filter abnormal data. Furthermore, the collection unit can monitor the animal's health status in real time and adjust the frequency of data collection according to the fatigue state. By filtering data according to the animal's health status in this way, accurate data can be collected. Some or all of the above-described processing in the collection unit may be performed using AI, or may be performed without using AI. For example, the collection unit can input the animal's health status data to generative AI and have the generative AI perform the data filtering.

The collection unit can estimate the emotion of an animal and determine the priority of data to be collected based on the estimated emotion of the animal. The collection unit estimates the emotion of an animal and determines the priority of data to be collected based on the estimated emotion of the animal. For example, if the animal is excited, heart rate data is collected preferentially. If the animal is relaxed, body temperature data can also be collected preferentially. Furthermore, if the animal is anxious, movement pattern data can also be collected preferentially. For example, the collection unit analyzes the animal's heart rate data and collects it preferentially when there are large fluctuations in heart rate. The collection unit can also analyze the animal's body temperature data and collect it preferentially when there are large fluctuations in body temperature. Furthermore, the collection unit can analyze the animal's movement pattern data and collect it preferentially when there are large fluctuations in movement. By determining the priority of data according to the animal's emotions in this way, important data can be collected preferentially. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the collection unit may be performed using AI, or may be performed without using AI. For example, the collection unit can input the animal's emotion data to generative AI and have the generative AI perform the determination of data priority.

The collection unit can prioritize the collection of highly relevant data by considering the animal's geographic location information when collecting data from the sensors. The collection unit prioritizes the collection of highly relevant data by considering the animal's geographic location information when collecting data from the sensors. For example, if the animal is in a specific region, data from that region is collected preferentially. If the animal is moving, data along the movement route can also be collected preferentially. Furthermore, if the animal exhibits abnormal behavior at a specific location, data from that location can also be collected preferentially. For example, the collection unit analyzes the animal's GPS data and collects data from that region preferentially when the animal is in a specific region. The collection unit can also analyze the animal's movement route data and collect data along the movement route preferentially when the animal is moving. Furthermore, the collection unit can analyze the animal's behavioral pattern data and collect data from that location preferentially when the animal exhibits abnormal behavior at a specific location. By considering the animal's geographic location information in this way, highly relevant data can be collected preferentially. Some or all of the above-described processing in the collection unit may be performed using AI, or may be performed without using AI. For example, the collection unit can input the animal's geographic location information data to generative AI and have the generative AI perform the prioritized collection of highly relevant data.

The collection unit can analyze the animal owner's social media activity when collecting data from the sensors and collect relevant data. The collection unit analyzes the animal owner's social media activity when collecting data from the sensors and collects relevant data. For example, if the owner reports abnormal behavior of the animal on social media, data related to that behavior is collected. If the owner is participating in a specific event, data related to that event can also be collected. Furthermore, if the owner shares the animal's health status on social media, data can also be collected based on that information. For example, the collection unit analyzes the owner's social media posts and collects data related to the animal's abnormal behavior. The collection unit can also analyze the owner's social media activity and collect data related to specific events. Furthermore, the collection unit can analyze the owner's social media posts and collect data related to the animal's health status. By analyzing the owner's social media activity in this way, relevant data can be collected. Some or all of the above-described processing in the collection unit may be performed using AI, or may be performed without using AI. For example, the collection unit can input the owner's social media data to generative AI and have the generative AI perform the collection of relevant data.

The analysis unit can estimate the emotion of an animal and adjust the analysis algorithm based on the estimated emotion of the animal. The analysis unit estimates the emotion of an animal and adjusts the analysis algorithm based on the estimated emotion of the animal. For example, if the animal is excited, the analysis algorithm for heart rate data is adjusted. If the animal is relaxed, the analysis algorithm for body temperature data can also be adjusted. Furthermore, if the animal is anxious, the analysis algorithm for movement pattern data can also be adjusted. For example, the analysis unit analyzes the animal's heart rate data and adjusts the analysis algorithm when there are large fluctuations in heart rate. The analysis unit can also analyze the animal's body temperature data and adjust the analysis algorithm when there are large fluctuations in body temperature. Furthermore, the analysis unit can analyze the animal's movement pattern data and adjust the analysis algorithm when there are large fluctuations in movement. By adjusting the analysis algorithm according to the animal's emotions in this way, the accuracy of the analysis is improved. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the analysis unit may be performed using AI, or may be performed without using AI. For example, the analysis unit can input the animal's emotion data to generative AI and have the generative AI perform the adjustment of the analysis algorithm.

The analysis unit can refer to the animal's past data during analysis to improve the accuracy of the analysis. The analysis unit refers to the animal's past data during analysis to improve the accuracy of the analysis. For example, the animal's past heart rate data is referenced to analyze the current data. The animal's past body temperature data can also be referenced to analyze the current data. Furthermore, the animal's past movement pattern data can also be referenced to analyze the current data. For example, the analysis unit analyzes the animal's past heart rate data and compares it with the current heart rate data. The analysis unit can also analyze the animal's past body temperature data and compare it with the current body temperature data. Furthermore, the analysis unit can analyze the animal's past movement pattern data and compare it with the current movement pattern data. By referring to the animal's past data in this way, the accuracy of the analysis is improved. Some or all of the above-described processing in the analysis unit may be performed using AI, or may be performed without using AI. For example, the analysis unit can input the animal's past data to generative AI and have the generative AI perform the accuracy improvement of the analysis.

The analysis unit can apply different analysis methods for each animal species during analysis. The analysis unit applies different analysis methods for each animal species during analysis. For example, when analyzing dog data, an analysis method that takes into account dog-specific behavioral patterns is applied. When analyzing cat data, an analysis method that takes into account cat-specific behavioral patterns can also be applied. Furthermore, when analyzing bird data, an analysis method that takes into account bird-specific behavioral patterns can also be applied. For example, the analysis unit analyzes dog behavioral patterns and applies an analysis method that takes into account dog-specific behavioral patterns. The analysis unit can also analyze cat behavioral patterns and apply an analysis method that takes into account cat-specific behavioral patterns. Furthermore, the analysis unit can analyze bird behavioral patterns and apply an analysis method that takes into account bird-specific behavioral patterns. By applying different analysis methods for each animal species in this way, the accuracy of the analysis is improved. Some or all of the above-described processing in the analysis unit may be performed using AI, or may be performed without using AI. For example, the analysis unit can input data for each animal species to generative AI and have the generative AI perform the application of different analysis methods.

The analysis unit can estimate the emotion of an animal and adjust the display method of analysis results based on the estimated emotion of the animal. The analysis unit estimates the emotion of an animal and adjusts the display method of analysis results based on the estimated emotion of the animal. For example, if the animal is excited, heart rate data is emphasized in the display. If the animal is relaxed, body temperature data can also be displayed in detail. Furthermore, if the animal is anxious, movement pattern data can also be emphasized in the display. For example, the analysis unit analyzes the animal's heart rate data and emphasizes the display of heart rate data when there are large fluctuations in heart rate. The analysis unit can also analyze the animal's body temperature data and display body temperature data in detail when there are large fluctuations in body temperature. Furthermore, the analysis unit can analyze the animal's movement pattern data and emphasize the display of movement pattern data when there are large fluctuations in movement. By adjusting the display method of analysis results according to the animal's emotions in this way, a more understandable display is possible. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the analysis unit may be performed using AI, or may be performed without using AI. For example, the analysis unit can input the animal's emotion data to generative AI and have the generative AI perform the adjustment of the display method of analysis results.

The analysis unit can perform analysis by considering the animal's geographic distribution during analysis. The analysis unit performs analysis by considering the animal's geographic distribution during analysis. For example, if the animal is in a specific region, data from that region is prioritized for analysis. If the animal is moving, data along the movement route can also be prioritized for analysis. Furthermore, if the animal exhibits abnormal behavior at a specific location, data from that location can also be prioritized for analysis. For example, the analysis unit analyzes the animal's GPS data and prioritizes the analysis of data from that region when the animal is in a specific region. The analysis unit can also analyze the animal's movement route data and prioritize the analysis of data along the movement route when the animal is moving. Furthermore, the analysis unit can analyze the animal's behavioral pattern data and prioritize the analysis of data from that location when the animal exhibits abnormal behavior at a specific location. By considering the animal's geographic distribution in this way, more relevant analysis is possible. Some or all of the above-described processing in the analysis unit may be performed using AI, or may be performed without using AI. For example, the analysis unit can input the animal's geographic distribution data to generative AI and have the generative AI perform the prioritized analysis of highly relevant data.

The analysis unit can refer to related literature on animals during analysis to improve the accuracy of the analysis. The analysis unit refers to related literature on animals during analysis to improve the accuracy of the analysis. For example, the latest research papers on animal behavior are referenced for analysis. Literature on physiological changes in animals can also be referenced for analysis. Furthermore, past research data on animal earthquake prediction can also be referenced for analysis. For example, the analysis unit refers to the latest research papers on animal behavior and reflects them in the analysis. The analysis unit can also refer to literature on physiological changes in animals and reflect them in the analysis. Furthermore, the analysis unit can refer to past research data on animal earthquake prediction and reflect them in the analysis. By referring to related literature on animals in this way, the accuracy of the analysis is improved. Some or all of the above-described processing in the analysis unit may be performed using AI, or may be performed without using AI. For example, the analysis unit can input related literature data on animals to generative AI and have the generative AI perform the accuracy improvement of the analysis.

The generation unit can estimate the emotion of an animal and adjust the method of generating prediction information based on the estimated emotion of the animal. The generation unit estimates the emotion of an animal and adjusts the method of generating prediction information based on the estimated emotion of the animal. For example, if the animal is excited, prediction information is generated based on heart rate data. If the animal is relaxed, prediction information can also be generated based on body temperature data. Furthermore, if the animal is anxious, prediction information can also be generated based on movement pattern data. For example, the generation unit analyzes the animal's heart rate data and generates prediction information when there are large fluctuations in heart rate. The generation unit can also analyze the animal's body temperature data and generate prediction information when there are large fluctuations in body temperature. Furthermore, the generation unit can analyze the animal's movement pattern data and generate prediction information when there are large fluctuations in movement. By adjusting the method of generating prediction information according to the animal's emotions in this way, more accurate prediction information can be generated. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the generation unit may be performed using AI, or may be performed without using AI. For example, the generation unit can input the animal's emotion data to generative AI and have the generative AI perform the adjustment of the method of generating prediction information.

The generation unit can refer to the animal's past behavioral patterns when generating prediction information to improve the accuracy of generation. The generation unit refers to the animal's past behavioral patterns when generating prediction information to improve the accuracy of generation. For example, the animal's past heart rate data is referenced to generate current prediction information. The animal's past body temperature data can also be referenced to generate current prediction information. Furthermore, the animal's past movement pattern data can also be referenced to generate current prediction information. For example, the generation unit analyzes the animal's past heart rate data and generates prediction information by comparing it with the current heart rate data. The generation unit can also analyze the animal's past body temperature data and generate prediction information by comparing it with the current body temperature data. Furthermore, the generation unit can analyze the animal's past movement pattern data and generate prediction information by comparing it with the current movement pattern data. By referring to the animal's past behavioral patterns in this way, the accuracy of prediction information is improved. Some or all of the above-described processing in the generation unit may be performed using AI, or may be performed without using AI. For example, the generation unit can input the animal's past behavioral pattern data to generative AI and have the generative AI perform the accuracy improvement of prediction information generation.

The generation unit can apply different generation algorithms for each animal species when generating prediction information. The generation unit applies different generation algorithms for each animal species when generating prediction information. For example, when generating prediction information based on dog data, a generation algorithm that takes into account dog-specific behavioral patterns is applied. When generating prediction information based on cat data, a generation algorithm that takes into account cat-specific behavioral patterns can also be applied. Furthermore, when generating prediction information based on bird data, a generation algorithm that takes into account bird-specific behavioral patterns can also be applied. For example, the generation unit analyzes dog behavioral patterns and applies a generation algorithm that takes into account dog-specific behavioral patterns. The generation unit can also analyze cat behavioral patterns and apply a generation algorithm that takes into account cat-specific behavioral patterns. Furthermore, the generation unit can analyze bird behavioral patterns and apply a generation algorithm that takes into account bird-specific behavioral patterns. By applying different generation algorithms for each animal species in this way, the accuracy of prediction information is improved. Some or all of the above-described processing in the generation unit may be performed using AI, or may be performed without using AI. For example, the generation unit can input data for each animal species to generative AI and have the generative AI perform the application of different generation algorithms.

The generation unit can estimate the emotion of an animal and adjust the display method of prediction information based on the estimated emotion of the animal. The generation unit estimates the emotion of an animal and adjusts the display method of prediction information based on the estimated emotion of the animal. For example, if the animal is excited, heart rate data is emphasized in the display. If the animal is relaxed, body temperature data can also be displayed in detail. Furthermore, if the animal is anxious, movement pattern data can also be emphasized in the display. For example, the generation unit analyzes the animal's heart rate data and emphasizes the display of heart rate data when there are large fluctuations in heart rate. The generation unit can also analyze the animal's body temperature data and display body temperature data in detail when there are large fluctuations in body temperature. Furthermore, the generation unit can analyze the animal's movement pattern data and emphasize the display of movement pattern data when there are large fluctuations in movement. By adjusting the display method of prediction information according to the animal's emotions in this way, a more understandable display is possible. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the generation unit may be performed using AI, or may be performed without using AI. For example, the generation unit can input the animal's emotion data to generative AI and have the generative AI perform the adjustment of the display method of prediction information.

The generation unit can perform generation by considering the animal's geographic distribution when generating prediction information. The generation unit performs generation by considering the animal's geographic distribution when generating prediction information. For example, if the animal is in a specific region, prediction information is generated based on data from that region. If the animal is moving, prediction information can also be generated based on data along the movement route. Furthermore, if the animal exhibits abnormal behavior at a specific location, prediction information can also be generated based on data from that location. For example, the generation unit analyzes the animal's GPS data and generates prediction information based on data from that region when the animal is in a specific region. The generation unit can also analyze the animal's movement route data and generate prediction information based on data along the movement route when the animal is moving. Furthermore, the generation unit can analyze the animal's behavioral pattern data and generate prediction information based on data from that location when the animal exhibits abnormal behavior at a specific location. By considering the animal's geographic distribution in this way, more relevant prediction information can be generated. Some or all of the above-described processing in the generation unit may be performed using AI, or may be performed without using AI. For example, the generation unit can input the animal's geographic distribution data to generative AI and have the generative AI perform the prioritized generation of highly relevant data.

The generation unit can refer to related literature on animals when generating prediction information to improve the accuracy of generation. The generation unit refers to related literature on animals when generating prediction information to improve the accuracy of generation. For example, the latest research papers on animal behavior are referenced to generate prediction information. Literature on physiological changes in animals can also be referenced to generate prediction information. Furthermore, past research data on animal earthquake prediction can also be referenced to generate prediction information. For example, the generation unit refers to the latest research papers on animal behavior and reflects them in the prediction information. The generation unit can also refer to literature on physiological changes in animals and reflect them in the prediction information. Furthermore, the generation unit can refer to past research data on animal earthquake prediction and reflect them in the prediction information. By referring to related literature on animals in this way, the accuracy of prediction information is improved. Some or all of the above-described processing in the generation unit may be performed using AI, or may be performed without using AI. For example, the generation unit can input related literature data on animals to generative AI and have the generative AI perform the accuracy improvement of prediction information generation.

The provision unit can estimate the emotion of an animal and adjust the method of providing prediction information based on the estimated emotion of the animal. The provision unit estimates the emotion of an animal and adjusts the method of providing prediction information based on the estimated emotion of the animal. For example, if the animal is excited, heart rate data is emphasized in the provision. If the animal is relaxed, body temperature data can also be provided in detail. Furthermore, if the animal is anxious, movement pattern data can also be emphasized in the provision. For example, the provision unit analyzes the animal's heart rate data and emphasizes the provision of heart rate data when there are large fluctuations in heart rate. The provision unit can also analyze the animal's body temperature data and provide body temperature data in detail when there are large fluctuations in body temperature. Furthermore, the provision unit can analyze the animal's movement pattern data and emphasize the provision of movement pattern data when there are large fluctuations in movement. By adjusting the method of providing prediction information according to the animal's emotions in this way, more appropriate information provision is possible. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the provision unit may be performed using AI, or may be performed without using AI. For example, the provision unit can input the animal's emotion data to generative AI and have the generative AI perform the adjustment of the method of providing prediction information.

The provision unit can refer to past earthquake data of the region when providing prediction information to improve the accuracy of provision. The provision unit refers to past earthquake data of the region when providing prediction information to improve the accuracy of provision. For example, current prediction information is provided based on past earthquake data of the region. The reliability of prediction information can also be improved by referring to past earthquake data of the region. Furthermore, the method of providing prediction information can be adjusted based on past earthquake data of the region. For example, the provision unit analyzes past earthquake records of the region and reflects them in the current prediction information. The provision unit can also analyze past seismic intensity data of the region and improve the reliability of prediction information. Furthermore, the provision unit can adjust the method of providing prediction information based on past earthquake data of the region. By referring to past earthquake data of the region in this way, the reliability of prediction information is improved. Some or all of the above-described processing in the provision unit may be performed using AI, or may be performed without using AI. For example, the provision unit can input past earthquake data of the region to generative AI and have the generative AI perform the accuracy improvement of prediction information provision.

The provision unit can apply different provision methods for each regional disaster prevention system when providing prediction information. The provision unit applies different provision methods for each regional disaster prevention system when providing prediction information. For example, if the regional disaster prevention system uses SMS notifications, prediction information is provided via SMS. If the regional disaster prevention system uses app notifications, prediction information can also be provided via app notifications. Furthermore, if the regional disaster prevention system uses email notifications, prediction information can also be provided via email. For example, the provision unit analyzes the type of regional disaster prevention system and provides prediction information via SMS if SMS notifications are used. The provision unit can also provide prediction information via app notifications if the regional disaster prevention system uses app notifications. Furthermore, the provision unit can provide prediction information via email if the regional disaster prevention system uses email notifications. By applying provision methods according to the regional disaster prevention system in this way, more effective information provision is possible. Some or all of the above-described processing in the provision unit may be performed using AI, or may be performed without using AI. For example, the provision unit can input regional disaster prevention system data to generative AI and have the generative AI perform the application of different provision methods.

The provision unit can estimate the emotion of an animal and adjust the order of providing prediction information based on the estimated emotion of the animal. The provision unit estimates the emotion of an animal and adjusts the order of providing prediction information based on the estimated emotion of the animal. For example, if the animal is excited, heart rate data is provided first. If the animal is relaxed, body temperature data can also be provided first. Furthermore, if the animal is anxious, movement pattern data can also be provided first. For example, the provision unit analyzes the animal's heart rate data and provides heart rate data first when there are large fluctuations in heart rate. The provision unit can also analyze the animal's body temperature data and provide body temperature data first when there are large fluctuations in body temperature. Furthermore, the provision unit can analyze the animal's movement pattern data and provide movement pattern data first when there are large fluctuations in movement. By adjusting the order of providing prediction information according to the animal's emotions in this way, more appropriate information provision is possible. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the provision unit may be performed using AI, or may be performed without using AI. For example, the provision unit can input the animal's emotion data to generative AI and have the generative AI perform the adjustment of the order of providing prediction information.

The provision unit can provide prediction information by considering the geographic characteristics of the region when providing prediction information. The provision unit provides prediction information by considering the geographic characteristics of the region when providing prediction information. For example, if the region is a mountainous area, prediction information is provided considering the impact of earthquakes. If the region is an urban area, prediction information can also be provided considering the building density. Furthermore, if the region is a coastal area, prediction information can also be provided considering the risk of tsunamis. For example, the provision unit analyzes the region's topographic data and provides prediction information considering the impact of earthquakes if it is a mountainous area. The provision unit can also analyze the region's population distribution data and provide prediction information considering the building density if it is an urban area. Furthermore, the provision unit can analyze the region's coastal data and provide prediction information considering the risk of tsunamis if it is a coastal area. By considering the geographic characteristics of the region in this way, more relevant information provision is possible. Some or all of the above-described processing in the provision unit may be performed using AI, or may be performed without using AI. For example, the provision unit can input the region's geographic characteristic data to generative AI and have the generative AI perform the provision of highly relevant information.

The provision unit can refer to related literature of the region when providing prediction information to improve the accuracy of provision. The provision unit refers to related literature of the region when providing prediction information to improve the accuracy of provision. For example, prediction information is provided by referring to the latest research papers on earthquakes in the region. Prediction information can also be provided by referring to literature on disaster prevention in the region. Furthermore, prediction information can also be provided by referring to past earthquake data of the region. For example, the provision unit refers to the latest research papers on earthquakes in the region and reflects them in the prediction information. The provision unit can also refer to literature on disaster prevention in the region and reflect them in the prediction information. Furthermore, the provision unit can refer to past earthquake data of the region and reflect them in the prediction information. By referring to related literature of the region in this way, the accuracy of prediction information is improved. Some or all of the above-described processing in the provision unit may be performed using AI, or may be performed without using AI. For example, the provision unit can input related literature data of the region to generative AI and have the generative AI perform the accuracy improvement of prediction information provision.

### ===Hardware Guarantee 1-1===

Each of the multiple elements including the above-described collection unit, analysis unit, generation unit, and provision unit is realized, for example, by at least one of the smart device 14 and the data processing apparatus 12. For example, the collection unit monitors the animal's heart rate, body temperature, and movement patterns in real time using the sensors of the smart device 14. The analysis unit is realized, for example, by the specific processing unit 290 of the data processing apparatus 12 and analyzes the collected data. The generation unit is realized, for example, by the specific processing unit 290 of the data processing apparatus 12 and generates prediction information based on the analysis results. The provision unit is realized, for example, by the control unit 46A of the smart device 14 and provides the generated prediction information to the regional disaster prevention system.

### ===Hardware Guarantee 1-2===

Each of the multiple elements including the above-described collection unit, analysis unit, generation unit, and provision unit is realized, for example, by at least one of the smart glasses 214 and the data processing apparatus 12. For example, the collection unit monitors the animal's heart rate, body temperature, and movement patterns in real time using the sensors of the smart glasses 214. The analysis unit is realized, for example, by the specific processing unit 290 of the data processing apparatus 12 and analyzes the collected data. The generation unit is realized, for example, by the specific processing unit 290 of the data processing apparatus 12 and generates prediction information based on the analysis results. The provision unit is realized, for example, by the control unit 46A of the smart glasses 214 and provides the generated prediction information to the regional disaster prevention system.

### ===Hardware Guarantee 1-3===

Each of the multiple elements including the above-described collection unit, analysis unit, generation unit, and provision unit is realized, for example, by at least one of the headset-type terminal 314 and the data processing apparatus 12. For example, the collection unit monitors the animal's heart rate, body temperature, and movement patterns in real time using the sensors of the headset-type terminal 314. The analysis unit is realized, for example, by the specific processing unit 290 of the data processing apparatus 12 and analyzes the collected data. The generation unit is realized, for example, by the specific processing unit 290 of the data processing apparatus 12 and generates prediction information based on the analysis results. The provision unit is realized, for example, by the control unit 46A of the headset-type terminal 314 and provides the generated prediction information to the regional disaster prevention system.

### ===Hardware Guarantee 1-4===

Each of the multiple elements including the above-described collection unit, analysis unit, generation unit, and provision unit is realized, for example, by at least one of the robot 414 and the data processing apparatus 12. For example, the collection unit monitors the animal's heart rate, body temperature, and movement patterns in real time using the sensors of the robot 414. The analysis unit is realized, for example, by the specific processing unit 290 of the data processing apparatus 12 and analyzes the collected data. The generation unit is realized, for example, by the specific processing unit 290 of the data processing apparatus 12 and generates prediction information based on the analysis results. The provision unit is realized, for example, by the control unit 46A of the robot 414 and provides the generated prediction information to the regional disaster prevention system.

The system according to the embodiment is not limited to the examples described above, and various modifications are possible, for example, as follows.

The collection unit can estimate the emotion of an animal and adjust the sensitivity of the sensor based on the estimated emotion of the animal. For example, if the animal is excited, the sensitivity of the heart rate sensor is increased to collect detailed data. If the animal is relaxed, the sensitivity of the body temperature sensor can be adjusted to detect subtle changes. Furthermore, if the animal is anxious, the sensitivity of the acceleration sensor can be increased to record movement patterns in detail. By adjusting the sensitivity of the sensors according to the animal's emotions in this way, more accurate data can be collected.

The collection unit can analyze the animal's past behavioral history and select the optimal sensor placement. For example, if the animal has exhibited abnormal behavior at a specific location in the past, sensors are concentrated at that location. The placement of heart rate sensors and body temperature sensors can also be optimized based on the animal's past behavioral patterns. Furthermore, if the animal exhibits abnormal behavior at a specific time of day, the sensitivity of the sensors can be increased during that time period. By selecting the optimal sensor placement based on the animal's past behavioral history in this way, the accuracy of data collection is improved.

The collection unit can perform filtering based on the animal's current health status when collecting data from the sensors. For example, if the animal is healthy, normal data collection is performed. If the animal is ill, abnormal data can be filtered to collect accurate data. Furthermore, if the animal is tired, the frequency of data collection can be adjusted to reduce the burden. By filtering data according to the animal's health status in this way, accurate data can be collected.

The collection unit can estimate the emotion of an animal and determine the priority of data to be collected based on the estimated emotion of the animal. For example, if the animal is excited, heart rate data is collected preferentially. If the animal is relaxed, body temperature data can also be collected preferentially. Furthermore, if the animal is anxious, movement pattern data can also be collected preferentially. By determining the priority of data according to the animal's emotions in this way, important data can be collected preferentially.

The collection unit can prioritize the collection of highly relevant data by considering the animal's geographic location information when collecting data from the sensors. For example, if the animal is in a specific region, data from that region is collected preferentially. If the animal is moving, data along the movement route can also be collected preferentially. Furthermore, if the animal exhibits abnormal behavior at a specific location, data from that location can also be collected preferentially. By considering the animal's geographic location information in this way, highly relevant data can be collected preferentially.

The analysis unit can estimate the emotion of an animal and adjust the analysis algorithm based on the estimated emotion of the animal. For example, if the animal is excited, the analysis algorithm for heart rate data is adjusted. If the animal is relaxed, the analysis algorithm for body temperature data can also be adjusted. Furthermore, if the animal is anxious, the analysis algorithm for movement pattern data can also be adjusted. By adjusting the analysis algorithm according to the animal's emotions in this way, the accuracy of the analysis is improved.

The analysis unit can refer to the animal's past data during analysis to improve the accuracy of the analysis. For example, the animal's past heart rate data is referenced to analyze the current data. The animal's past body temperature data can also be referenced to analyze the current data. Furthermore, the animal's past movement pattern data can also be referenced to analyze the current data. By referring to the animal's past data in this way, the accuracy of the analysis is improved.

The analysis unit can apply different analysis methods for each animal species during analysis. For example, when analyzing dog data, an analysis method that takes into account dog-specific behavioral patterns is applied. When analyzing cat data, an analysis method that takes into account cat-specific behavioral patterns can also be applied. Furthermore, when analyzing bird data, an analysis method that takes into account bird-specific behavioral patterns can also be applied. By applying different analysis methods for each animal species in this way, the accuracy of the analysis is improved.

The analysis unit can estimate the emotion of an animal and adjust the display method of analysis results based on the estimated emotion of the animal. For example, if the animal is excited, heart rate data is emphasized in the display. If the animal is relaxed, body temperature data can also be displayed in detail. Furthermore, if the animal is anxious, movement pattern data can also be emphasized in the display. By adjusting the display method of analysis results according to the animal's emotions in this way, a more understandable display is possible.

The analysis unit can perform analysis by considering the animal's geographic distribution during analysis. For example, if the animal is in a specific region, data from that region is prioritized for analysis. If the animal is moving, data along the movement route can also be prioritized for analysis. Furthermore, if the animal exhibits abnormal behavior at a specific location, data from that location can also be prioritized for analysis. By considering the animal's geographic distribution in this way, more relevant analysis is possible.

Below is a brief explanation of the process flow of Example 2 of the Embodiment.
Step 1: The collection unit collects data from sensors attached to animals. The sensors attached to animals include heart rate sensors, body temperature sensors, and acceleration sensors. The collection unit uses a heart rate sensor to monitor the animal's heart rate in real time, a body temperature sensor to measure the animal's body temperature, and an acceleration sensor to detect the animal's movement patterns. Data is collected when abnormal fluctuations or changes are detected.
Step 2: The analysis unit analyzes the data collected by the collection unit. The analysis unit analyzes the data using machine learning algorithms (for example, K-means, random forest, neural networks), and determines that an abnormal cluster, classification result, or pattern is a precursor to an earthquake.
Step 3: The generation unit generates prediction information based on the analysis results obtained by the analysis unit. The generation unit generates prediction information based on the analysis results using generative AI (for example, neural networks, generative models).
Step 4: The provision unit provides the prediction information generated by the generation unit. The provision unit provides the generated prediction information to regional disaster prevention systems (for example, alarm systems, evacuation guidance systems) and notifies local residents. The information can also be provided to local residents via web applications or mobile applications.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the devices or control units is not limited to the examples described above, and various modifications are possible.

### Second Embodiment

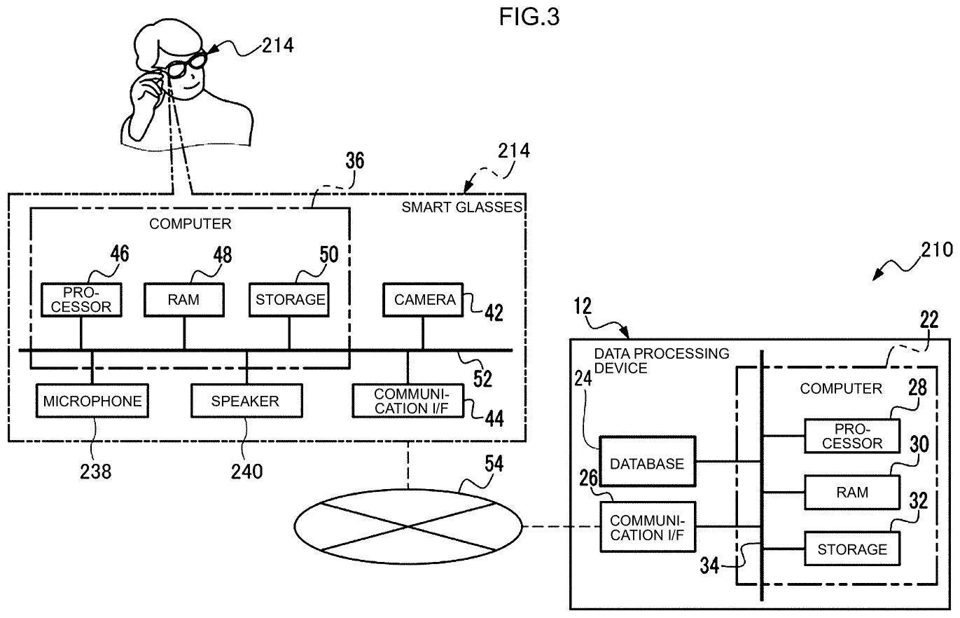

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

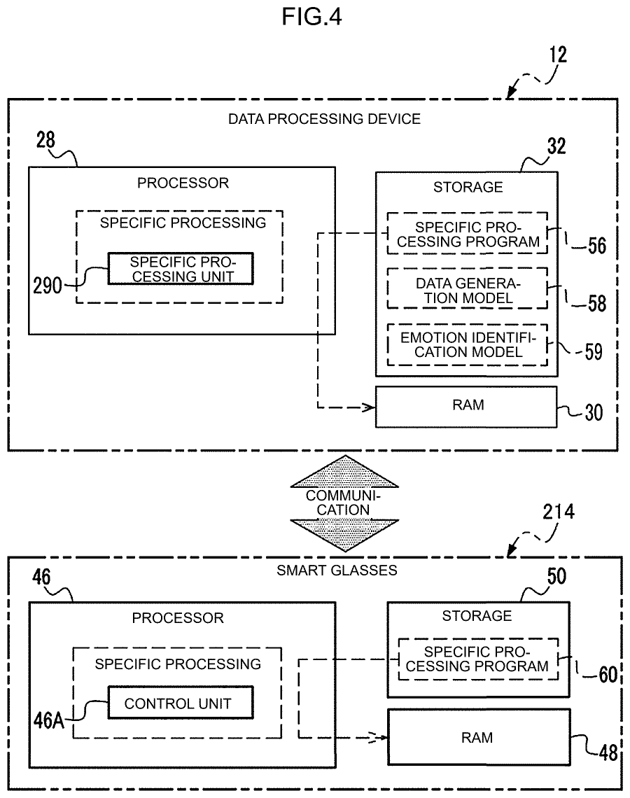

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the devices or control units is not limited to the examples described above, and various modifications are possible.

### Third Embodiment

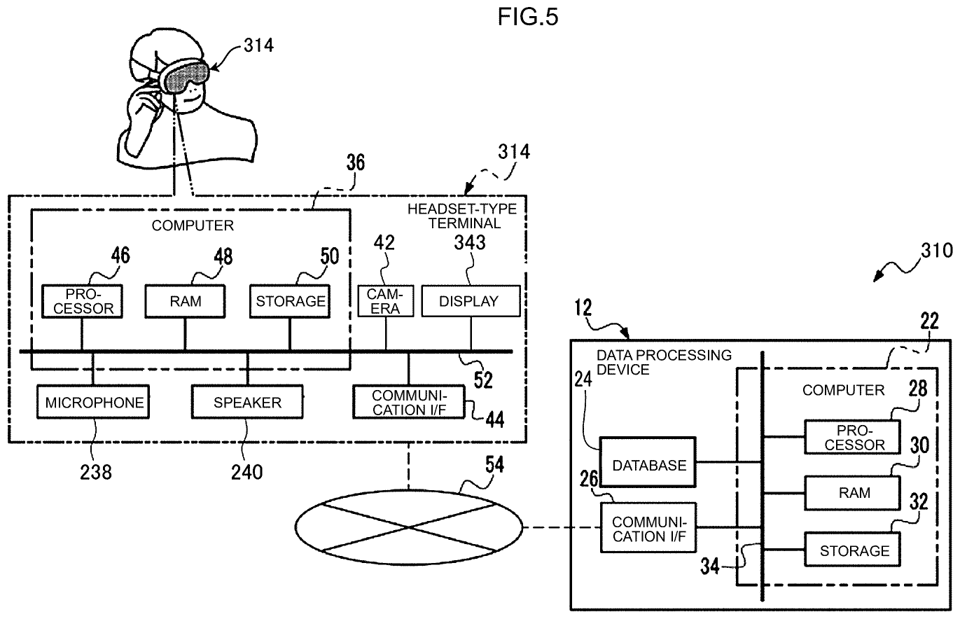

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

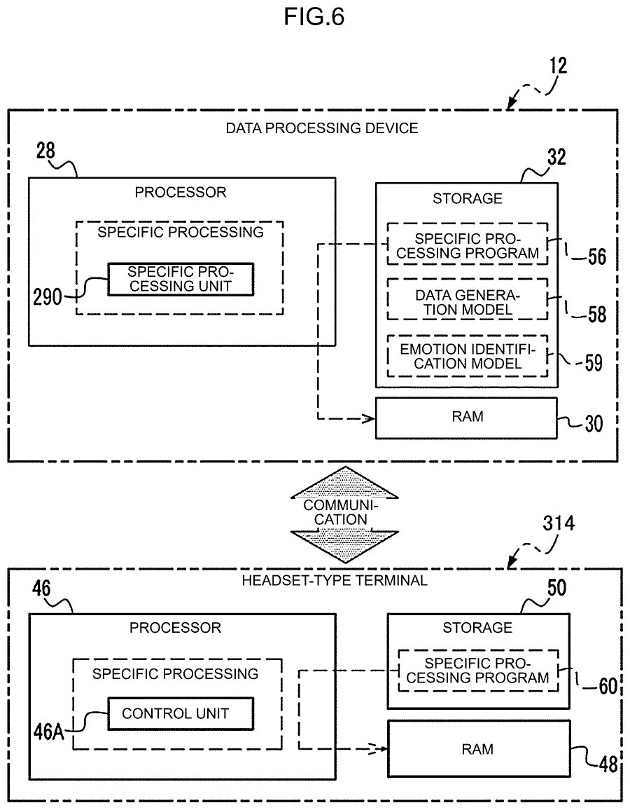

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the devices or control units is not limited to the examples described above, and various modifications are possible.

### Fourth Embodiment

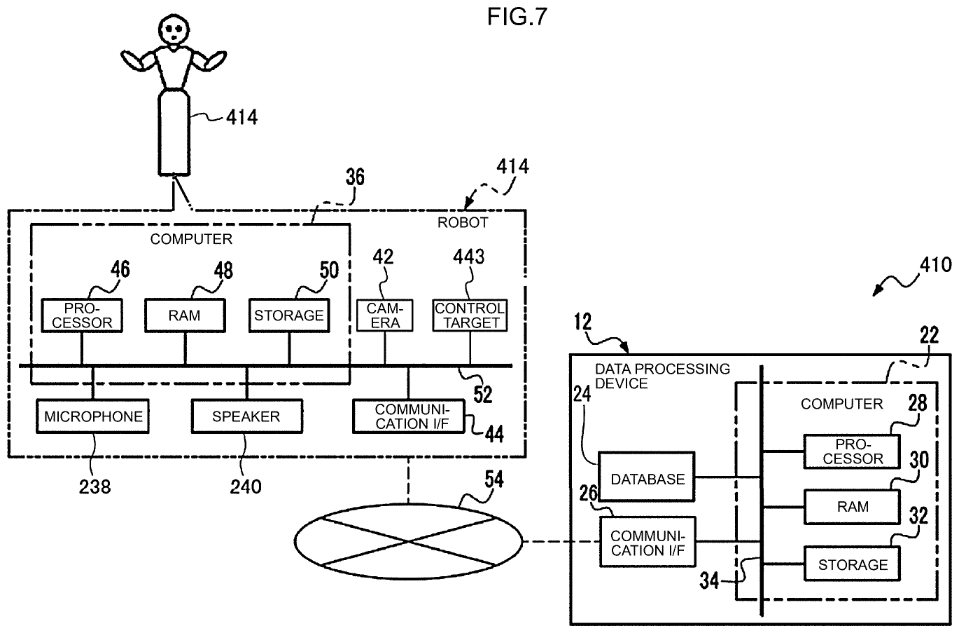

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

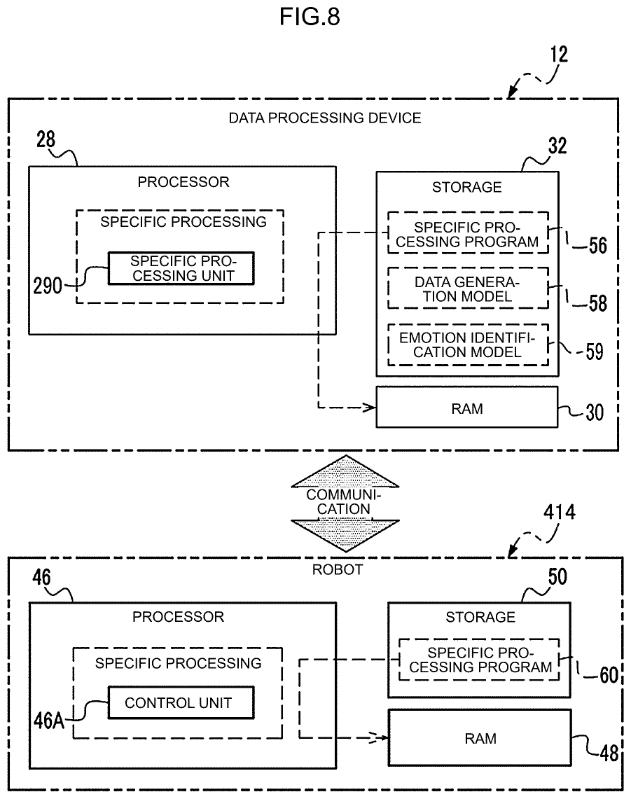

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the devices or control units is not limited to the examples described above, and various modifications are possible.

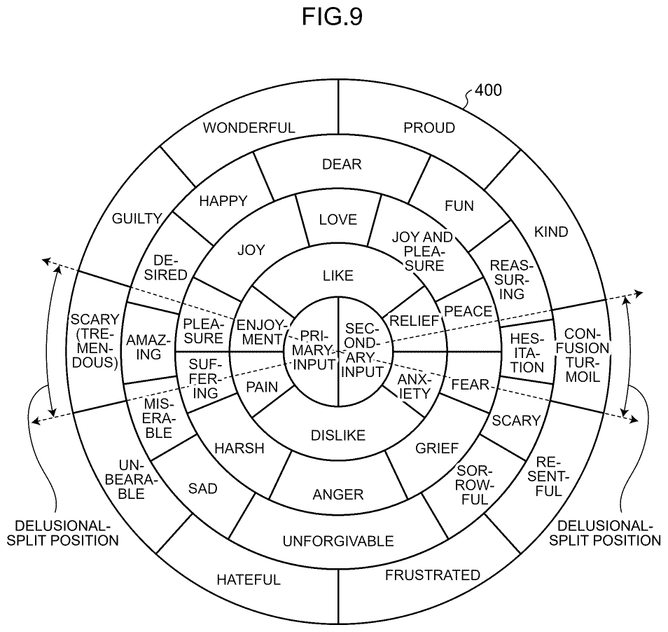

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

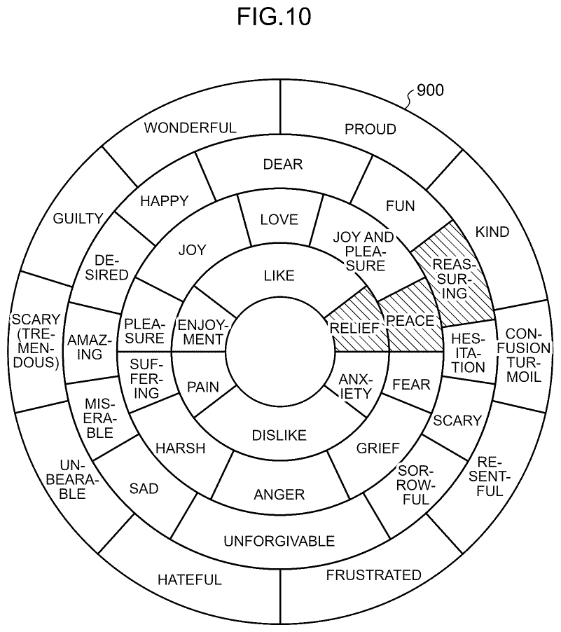

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: a collection unit that collects data from sensors attached to animals; an analysis unit that analyzes the data collected by the collection unit; a generation unit that generates prediction information based on the analysis results obtained by the analysis unit; and a provision unit that provides the prediction information generated by the generation unit.

2. The system according to claim 1, wherein the collection unit includes a heart rate sensor, a body temperature sensor, and an acceleration sensor.

3. The system according to claim 1, wherein the analysis unit analyzes data using a machine learning algorithm.

4. The system according to claim 1, wherein the generation unit generates prediction information using a generative AI.

5. The system according to claim 1, wherein the provision unit provides the generated prediction information to a regional disaster prevention system.

6. The system according to claim 1, wherein the collection unit provides a method for estimating the emotion of an animal and adjusting the sensitivity of the sensor based on the estimated emotion of the animal.

7. The system according to claim 1, wherein the collection unit analyzes the animal's past behavioral history and selects an appropriate sensor placement.

8. The system according to claim 1, wherein the collection unit performs filtering based on the animal's current health status when collecting data from the sensors.
